(19) United States
(12) Patent Application Publication
(10) Pub. No.: US 2016/0123539 A1
(43) Pub. Date: May 5, 2016

(54) ANTI-FROST CAP FOR LIQUID NITROGEN CONTAINERS OR OTHER COLD CONDENSED GASES

(71) Applicant: Centro de Investigación en Materiales Avanzados, S.C., Chihuahua (MX)

(72) Inventor: Mario MIKI YOSHIDA, Chihuahua (MX)

(21) Appl. No.: 14/925,069

(22) Filed: Oct. 28, 2015

(30) Foreign Application Priority Data
Oct. 30, 2014 (MX) MX/A/2014/013232

(51) Int. Cl. F17C 13/06; F17C 13/00; F17C 3/02

(52) U.S. Cl. CPC F17C 13/06; F17C 3/02; F17C 13/001

(57) ABSTRACT

The present invention refers to a cylindrical cavity or cap, which prevents the condensation and the crystallization of water vapor or other possible compounds present in the air, around the outlet vent of a container having condensate gas. It prevents the condensation and the crystallization of frost or other compounds because of the formation of an environment free of other compounds around the outlet vent with gases from their own evaporation of the condensate gases in the container

### OBJECT OF THE INVENTION

The present invention relates to a cap, which prevents the condensation and the crystallization of water steam (frost) or other compounds, around the output vent of containers containing liquid nitrogen or other cold condensate gas; in addition to allowing the free evacuation of the evaporated gas avoiding the increase of pressure in the container.

### BACKGROUND

A major problem in containers that store liquid nitrogen or other liquefied or condensed gases, which are at a very low temperature, is the formation of frost around the outlet vent of the tank, due to the condensation and the crystallization of water vapor or other vapors present. The problem arises when the condensed material falls inside the container, contaminating the present fluid, generating deposits of foreign matter in the walls of the container or the corrosion of the same, when the condensed material comes in contact with the surface; or also disrupting the functioning of a device attached to the container.

The prior art shows several patents teaching anti-frost devices for refrigeration, for example, the Mexican patent PA/a/1998/003977. That does not refer to containers containing liquefied or cold condensed gases. In addition, the principle used is by electric heating or by vents through which circulate a hot fluid.

Neither scientific publications relating to the object of the present invention were found.

### BRIEF DESCRIPTION OF THE FIGURES

FIG. 1 shows a cross-sectional view of the system anti-frost cap (1) placed over the outlet vent (3) of the container (2) that contains the cold condensate gas (4), which does not form part of the invention and has been outlined with a dotted line.

FIG. 2 shows a schematic view of the anti-frost cap including details of the lower taps (100) and the exhaust vent (103) of the evaporated gas in the container.

### DETAILED DESCRIPTION OF THE INVENTION

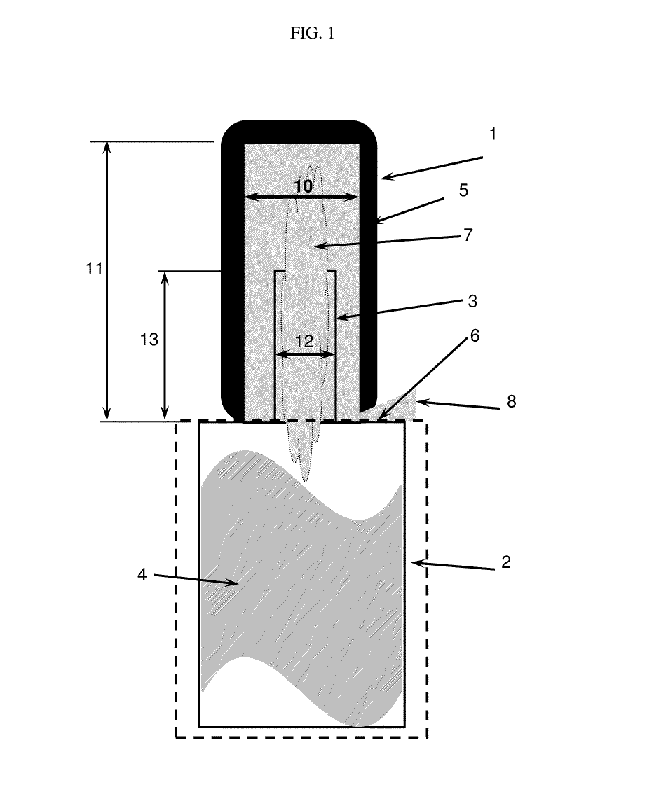

The anti-frost cap (1) of the present invention includes a hollow body, whose wall has a cylindrical shape and is closed on one end and open on the other end. The open end is placed over the outlet vent (3) from the container (2) which contains the condensed gas (4), as shown in FIG. 1. The wall (5) of the anti-frost cap (1), by its external face, is preferably made of a rigid material (glass, plastic, ceramic) coated internally of another material that is heat-insulating. The internal diameter (10) of the anti-frost cap (1) must be equal to or greater than twice the diameter (12) of the outlet vent (3) from the container (2) which contains the condensate gas (4). Likewise, the internal height (11) of the anti-frost cap is equal to or greater than twice the height (13) of the outlet vent (3) from the container (2) containing the condensate gas.

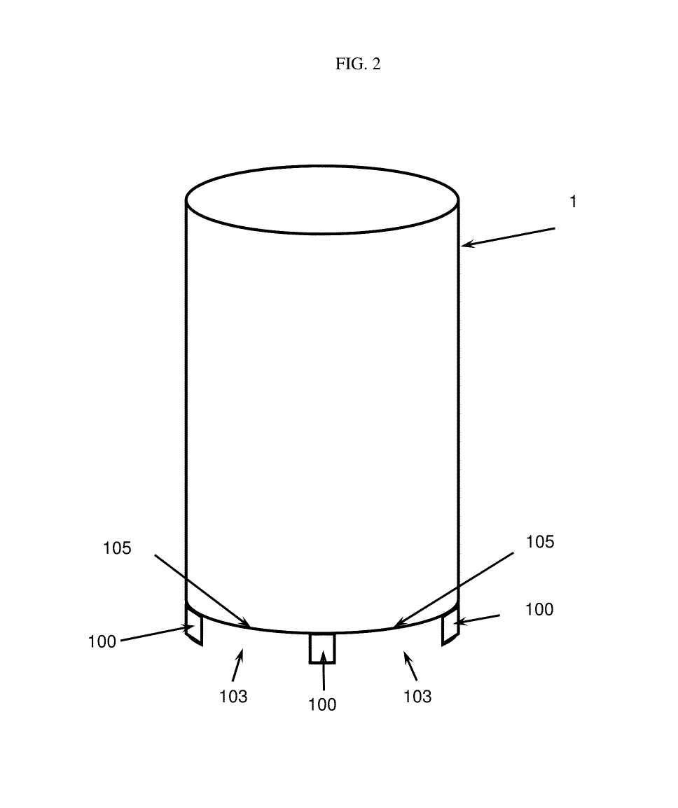

FIG. 2 shows a schematic view showing the details of the bottom edge of the anti-frost (1) cap. The wall of the bottom edge of the anti-frost cap (1) includes a plurality of taps (100), at least 3 of the taps have a square shape and the same thickness as the wall of the anti-frost cap (1), which serve as a support when placed in position on the top surface (6) of the container (2), around the outlet vent (3). In addition, between each tap (100), there are openings (103), at least 3 openings, between the rim (105) of the anti-frost cap and the top surface (6) of the container (2). The total surface of the anti-frost cap, i.e., the sum of the areas of all openings (103), etc., is equal to or greater than twice the area of the outlet vent (3) of the container (2).

### Example

### Method of Use of the Anti-Frost Cap

After filling and thermal stabilizing the container (2) and the condensate gas (4), the anti-frost cap (1) placed, with its open end facing down, as shown in FIG. 1, over the upper surface (6) of the container (2), around the outlet vent (3) of the container, in order to prevent the condensation of the water vapor from the air environment and its crystallization around the outlet vent (3) of the container. The functioning of the anti-frost cap (1) is based on that because of the inevitable evaporation of the condensate gas (4) during storage, a continuous flow of cold gas (7) exists through the outlet vent (3), which cools the surrounding air and causes the condensation and subsequent crystallization of the water vapor or another compound, for example, organic contained in the air. The anti-frost cap (1) object of the present invention completely avoids the formation of frost or other compounds around the vent outlet (3), since the cold gas flow (7) that exists in the vent outlet (3) enters the inverted cylindrical cavity (1), creating an environment free of other gases or compounds; the released cold gas (7) escapes through the lower openings in the cap (8). Because of this operation principle, it is necessary to limit the internal dimensions (10) (11) of the cavity depending on the dimensions (12) (13) of the output vent (3). It is established that internal dimensions (10) (11) of the cavity should be at least twice the dimensions (12) (13) of the output vent (3). Also the taps (100) need to have dimensions that set the total escape surface of the gases through the bottom edge of the cap. These dimensions must be at least two times the section of the outlet vent (3).

1. An anti-frost cap for containers of liquid nitrogen or other cold condensed gases, comprising:
a hollow body having a wall with a cylindrical shape; a closed end; an open end; a lower rim (105) including at least three taps (100) having a square shape and having a thickness equal to the thickness of the wall; the internal diameter (10) of the anti-frost cap (1) is equal to or greater than twice a diameter of the outlet vent (3) of the container (2); and having an internal height (11) of the anti-frost cap is equal or greater than twice a height of the outlet vent (3) of the container (2).

2. The anti-frost cap for containers of liquid nitrogen or other cold condensate gas according to claim 1, wherein the wall (5) is made of a rigid material (glass, plastic, ceramic) in an external face and is coated internally with an insulating material.

3. The anti-frost cap for containers of liquid nitrogen or other cold condensate gas cap according to claim 1, wherein the taps (100) create at least three openings (103) between the rim (105) of the cap and the top surface (6) of the container (2).

4. The anti-frost cap for containers of liquid nitrogen or other cold condensate gas according to claim 3, wherein the openings (103) between the rim (105) of the cap and the top surface (6) of the container (2) have the sum their of areas equal to or greater than twice the outlet vent (3) of the container (2).
